(19) United States
(12) Patent Application Publication
(10) Pub. No.: US 2024/0215611 A1
(43) Pub. Date: Jul. 4, 2024

(54) LEGUME, PROTEIN. EXTRUDATE PRODUCTS AND DERIVATIVE FOOD PRODUCTS AND METHODS OF MANUFACTURE THEREOF

(71) Applicant: PURIS HOLDINGS, LLC, MINNEAPOLIS, MN (US)

(72) Inventors: RANDALL MARTIN, MINNEAPOLIS, MN (US); EMILEE LANCE, MINNEAPOLIS, MN (US); Courtney ROEN, MINNEAPOLIS, MN (US)

(21) Appl. No.: 18/149,052

(22) Filed: Dec. 30, 2022

(51) Int. Cl. A23J 3/22; A23J 3/14; A23J 3/26; A23L 11/00

(52) U.S. Cl. CPC A23J 3/227; A23J 3/14; A23J 3/26; A23L 11/05

(57) ABSTRACT

A legume, protein, extrudate product that may comprise a mixture of at least one carbohydrate product and at least two non-soy, legume, protein products. Each non-soy, legume, protein product may differ in pH, sedimentation level test value, Nitrogen Solubility Index test value, protein, Dispersibility Index test value, particle size distribution, and/or viscosity. The legume, protein products may comprise a distribution ratio ranging from a 50:50 distribution ratio to a 90:10 distribution ratio. The legume, protein, extrudate product may have at least 70% dry weight, may have a moisture content of less than 70% its total weight, and may have a density in the range of 0.8-3.0 g/cm³. A food product made from the extrude product that is comparable to meat products from fowl, cattle, swine, or ovine.

### TECHNOLOGY OF THE DISCLOSURE

The present disclosure relates generally to legume, protein, extrudate products, the methods of manufacture of the legume, protein, extrudate products, and the production of food products from the legume, protein, extrudate products.

### BACKGROUND OF THE DISCLOSURE

Since at least the domestication of livestock, animal meat has remained the dominant source of protein in human and animal diets. However, animal meat and its production have a plethora of negative aspects, such as: (i) high levels of fat content which may increase the risk of noncommunicable diseases (e.g., obesity, heart disease, stroke, etc.); (ii) harmful impacts on the environment (e.g., deforestation for herding and grazing and the large release of methane gas for cattle); (iii) the reductive effectiveness of the human immune systems through the overuse of antibiotics in livestock; (iv) the cruel and inhumane treatment of livestock and animals used in food production; etc.

However, despite all these negative attributes, meat production has not waned in recent years because of the popularity of the taste and texture of meat products and meat's high levels of protein, iron, zinc, vitamin-B12, omega-3 fatty acids, and other miscellaneous nutrients.

In recent years, product formulators have experimented with potential sources of non-animal derived protein material that could become meat substitutes with varying levels of success (e.g., plant derived burger patties). However, none of these attempts have created a true substitute for meat that may be comparable in terms of consistency, texture, taste, and/or appearance.

Additionally, some of the protein sources that have seen a large amount of experimentation by product formulators in recent years—namely, grains and whole wheat (e.g., gluten), milk and other dairy based products, and soybeans—can produce negative physical effects for many consumers. For example, soybeans, wheat gluten, and milk sourced proteins are classified as allergens by the Food and Drug Administration (FDA) which requires each of these ingredients to be specifically identified on all food product labels. Others, such as wheat and milk based proteins, are associated with physical intolerance, either directly (e.g., gluten in wheat sources) or through associated ingredients (e.g., lactose in milk sources).

In particular, much research and product development has been done by many commercial interests to create finished consumer products with soybean-based proteins as replacements for animal-based proteins for many of the already stated reasons. However, FDA considers soybean proteins as allergenic ingredients, and so they must be listed on labels. In addition, many consumers do not like the musty, beany flavor or the flatulence effect associated with soybean protein materials.

Another continuing challenge to plant protein material suppliers is creating protein material that has not only the physical characteristics comparable to that of meat, but also comparable flavor and color. The organoleptic properties of plant protein material could predominate or overwhelm the flavor or color ingredients added to a food product formulation, leaving the plant protein product with an unpleasant flavor. As more protein material is added to a formulation for the plant protein product, the organoleptic properties of that protein material will become more problematic. For example, protein material sourced from soybeans can have a beany, musty flavor that could be difficult to flavor formulate around.

Therefore, there remains a need for a protein product with the consistency, texture, taste, and/or appearance comparable to that of meat.

### SUMMARY OF THE DISCLOSURE

According to some possible implementations, a legume, protein, extrudate product that may comprise a mixture of at least one carbohydrate product and at least two non-soy, legume, protein products. Each non-soy, legume, protein product may differ in pH, sedimentation level test value, Nitrogen Solubility Index test value, Protein Dispersibility Index test value, particle size distribution, and/or viscosity. The non-soy, legume, protein products may comprise a distribution ratio ranging from a 50:50 distribution ratio to a 90:10 distribution ratio. The legume, protein, extrudate product may have at least 70% dry weight, may have a moisture content of less than 70% its total weight, and may have a density in the range of about 0.8-3.0 g/cm³.

According to some possible implementations, a method of manufacture of a legume, protein, extrudate product may comprise weighing at least two non-soy, legume, protein products and at least one carbohydrate product. The combination of the non-soy, legume, protein products and the carbohydrate product may have a range of 70-100% dry weight. The at least two non-soy, legume, protein products may have a distribution ratio ranging from a 50:50 distribution ratio to a 90:10 distribution ratio. The method of manufacture of a legume, protein, extrudate product may comprise mixing the at least two non-soy, legume, protein products and the at least one carbohydrate product to make a mixture of non-soy, legume, protein and carbohydrate products. Each of the at least two non-soy, legume, protein products may differ in pH, sedimentation level test value, Nitrogen Solubility Index test value, Protein Dispersibility Index test value, particle size distribution, and/or viscosity. The method of manufacture of a legume, protein, extrudate product may comprise preconditioning the mixture of non-soy, legume, protein and carbohydrate products by mixing the mixture of non-soy, legume, protein and carbohydrate products at a speed of about 100-1500 rpms, 300-1500 rpms, 500-1000 rpms, or any speed inside of those ranges. The method of manufacture of a legume, protein, extrudate product may comprise extruding the mixture of non-soy, legume, protein and carbohydrate products to make a legume, protein, extrudate. The method of manufacture of a legume, protein, extrudate product may comprise processing the legume, protein, extrudate by shearing, cutting, chopping, shredding, grinding, compressing, kneading, rolling, tumbling, tenderizing, reducing, darkening, boiling, broiling, grilling, frying, roasting, baking, smoking, steaming, dehydrating, pickling, marinating, and/or freeze drying legume, protein, extrudate.

According to some possible implementations, a meat-like food product may comprise the legume, protein, extrudate product previously described and an inner fibrous consistency, a smooth outer texture, a meat-like taste, and/or a meat-like appearance. The inner fibrous consistency, smooth outer texture, meat-like taste, and/or a meat-like appearance may be comparable to that of a cooked fowl meat product, a cooked cattle meat product, a cooked swine meat product, and/or a cooked ovine meat product.

### BRIEF DESCRIPTION OF THE DRAWINGS

The disclosed exemplary implementations of the invention will hereinafter be described in conjunction with the drawings provided to illustrate and not to limit the invention, where like designations denote like elements, and in which:

FIG. 1 is an overview diagram of an example implementation of the method described herein; and

FIG. 2 is a diagram of an example implementation of an extruder described herein.

### DETAILED DESCRIPTION OF THE DISCLOSURE

As described herein, a meat-like food product is provided which may serve as a substitute for cooked meat-based food products. In some implementations, the meat-like food product may be made from a legume, protein, extrudate product. Further, the meat-like product may have a consistency, appearance, taste, and/or texture comparable to a cooked meat-based food product of a fowl, a swine, a cattle, and/or an ovine.

In some implementations, the legume, protein, extrudate product may comprise a combination of non-soy, legume, protein products and carbohydrate products. The non-soy, legume, protein products and carbohydrate products may be mixed together to form a mixture of non-soy, legume protein and carbohydrate products. The mixture of non-soy, legume protein and carbohydrate products may be preconditioned and extruded to form a legume protein, extrudate product. The legume protein, extrudate product may be processed, injected with ingredients, cooled, and packaged. In this way, the legume, protein, extrudate product can be fashioned into a meat-like food product that is comparable to a cooked meat-based food product.

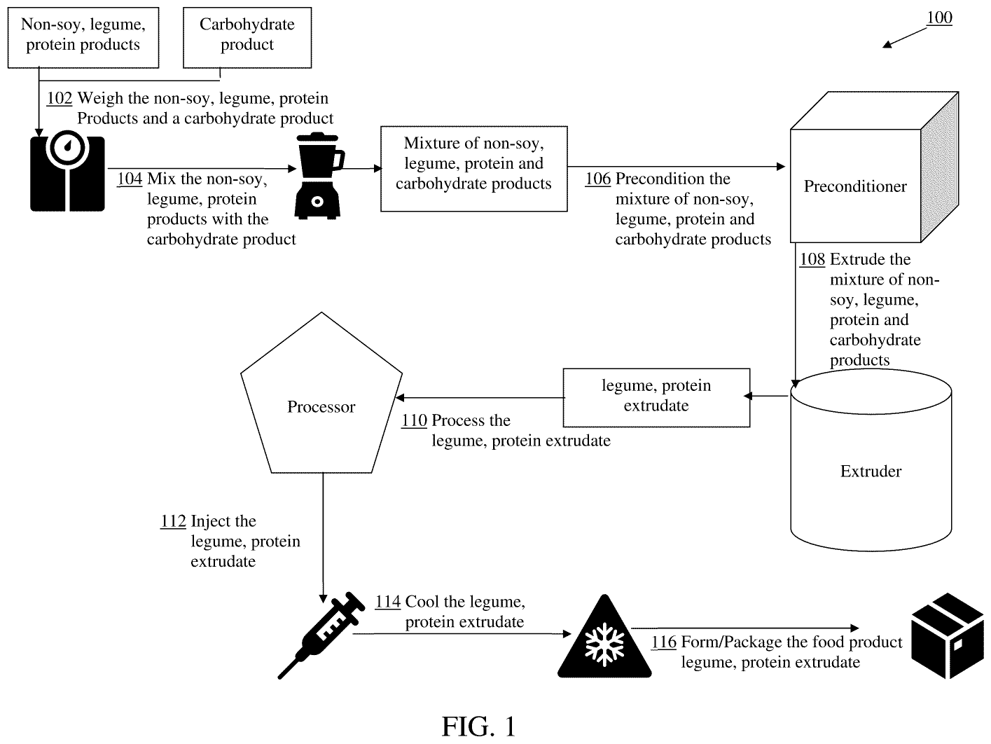

FIG. 1 is a diagram of example implementation 100 of a meat-like food product described herein. Example implementation 100 may comprise two or more non-soy, legume, protein products, one or more carbohydrate products, a scale, a mixer, a preconditioner, an extruder, a processor, an injector, a cooler, and a packer. The scale comprises a device capable of weighing a substance (e.g., a balance scale, a spring scale, etc.). For example, the scale can be used to weigh the two or more non-soy, legume, protein products and the one or more carbohydrate products. The mixer comprises a device capable of mixing two or more substances (e.g., a ribbon mixer, a paddle mixer, etc.). For example, the mixer can be used to mix the two or more non-soy, legume, protein products and the one or more carbohydrate products to form a mixture of non-soy, legume, protein and carbohydrate products. The preconditioner comprises a device capable of stirring two or more substances at high revolutions per minute at various temperatures. For example, the preconditioner can be used to stir the mixture of non-soy, legume, protein and carbohydrate products to form a legume, protein, pre-extrudate product. The extruder comprises a device capable of extruding a substance. For example, the extruder can extrude the legume, protein, pre-extrudate product to form the legume, protein, extrudate product. The processor comprises one or more devices capable of shearing, cutting, chopping, shredding, grinding, compressing, kneading, rolling, tumbling, tenderizing, reducing, darkening, boiling, broiling, grilling, frying, roasting, baking, smoking, steaming, dehydrating, pickling, marinating, and/or freeze drying the legume protein extrudate product. The injector comprises a device capable of injecting one or more ingredients or flavors into the processed extrudate and forming the flavored processed extrudate. The cooler comprises a device that houses a liquid and is capable of cooling and/or freezing the flavored processed extrudate, which can be the final food product. The liquid housed inside the cooler can be oil, water, or coolant. The liquid can enter the cooling die at a distal end of the cooling die and flow towards the proximate end of the cooling die that is closest to the extruder. This allows for gradual cooling of the processed extrudate product or flavored processed extrudate product, as the cooling liquid warms as it flows passed the cooler processed extrudate product or flavor processed extrudate product and towards the warmer processed extrudate product or flavor processed extrudate product. The warmed cooling liquid exits the cooling die at the proximate end of the cooling die. The packer comprises a device capable of packaging the final food product that comprises the non-soy, legume, protein products and/or carbohydrate products.

As shown by reference number 102, the scale may weigh non-soy, legume, protein products and/or carbohydrate products. Two or more non-soy, legume, protein products and one or more carbohydrate products may be selected for weighing. Non-soy, legume, protein products comprise products made out of non-soy, legume derived proteins. The non-soy, legume, protein products may have a range of 50-100% dry weight in protein, a pH range of about 4-8, a sedimentation buildup average range of less than 20 mL, a Nitrogen Solubility Index of less than 40, a Protein Dispersibility Index of less than 90, a protein solubility of greater than 10%, a protein content of greater than 50%, a particle size distribution of less than 10% the total particles having a diameter of less than 25 μm, less than 25% the total particles having a diameter of less than 30 μm, less than 50% the total particles having a diameter of less than 40 μm, less than 75% the total particles having a diameter of less than 50 μm, less than 90% the total particles having a diameter of less than 75 μm, less than 100% the total particles having a diameter of less than about 350 μm, and/or a viscosity greater than 50 cP, etc. Each non-soy, legume, protein product can be selected based on the pH of the solution the protein product was created in, the pH of the protein, protein solubility, protein content, sedimentation level test value, Nitrogen Solubility Index test value, Dispersibility Index test value, particle size distribution, viscosity, and/or the like or combination thereof. Carbohydrates comprise sugars (e.g., fructose, glucose, sucrose, etc.) and/or soluble substances separated from the non-soy, legume, protein products (e.g., starch and fiber legume seed portions, etc.). Each carbohydrate product may be selected from a legume, starch product, a legume, flour product, a legume, fiber product, and/or the like or combination thereof.

The non-soy, legume, protein products may have different pH levels. The non-soy, legume, protein products may comprise a distribution ratio in terms of dry weight that ranges from an equal distribution ratio between all the individual non-soy, legume, protein products to about a 90% distribution ratio of one of the non-soy, legume, protein products with all the others. For example, in one implementation, two non-soy, legume, protein products that comprise different pHs, sedimentation level test values, Nitrogen Solubility Index test values, protein, Dispersibility Index test values, particle size distributions, and/or viscosities may be selected. In this implementation, the distribution ratio of dry weight ranges from about 50:50 to about 90:10. In another implementation, three non-soy, legume protein products that each comprise different pHs, sedimentation level test values, Nitrogen Solubility Index test values, protein, Dispersibility Index test values, particle size distributions, and/or viscosities may be selected. In this implementation, the distribution ratio of dry weight ranges from an equal distribution of about 33.3% between the three to a ratio distribution of one non-soy, legume protein product of about 90% with the other two non-soy, legume protein products of about equal 5%. The non-soy, legume, protein products also may comprise a distribution ratio in terms of dry weight that ranges from at least a 70:30 ratio between the non-soy, legume, protein products and the carbohydrate products. For example, in one implementation, the total dry weight of the non-soy, legume, protein products make up 70% dry weight whereas the carbohydrate product makes up 30% dry weight.

As shown by reference number 104, after the scale weighs the non-soy, legume, protein products and carbohydrate products, the mixer may mix the non-soy, legume protein products and the carbohydrate products together into a mixture of non-soy, legume, protein and carbohydrate products. The mixture of non-soy, legume, protein and carbohydrate products may be mixed until homogenous. In some implementations, about 0.1-3.0% of water and/or oil may be added to the mixture to reduce the levels of static electricity and dust-like particles. In some other implementations, about 3-30% of water and/or oil may be added to the mixture to pre-hydrate the mixture of non-soy, legume, protein and carbohydrate products for wetter based protein products and/or for recipes/ingredients that need longer hydration time, (e.g., pet food, etc.).

As shown by reference number 106, after the mixer mixes the non-soy, legume, protein products and carbohydrate products, the preconditioner may precondition the mixture of non-soy, legume, protein and carbohydrate products to form a legume, protein, pre-extrudate product. The preconditioner may mix the mixture of non-soy, legume, protein and carbohydrate products at speeds of 300-1500 rpms. The preconditioning may comprise at least one mixing barrel featuring a central rotating shaft but may contain multiple interconnected barrels and rotating shafts. In some implementations, various levels of water, oil, steam, and/or other liquids may be added to the preconditioner to produce different desired results in the legume, protein, pre-extrudate product. In some implementations, ingredients may also be added into the preconditioner, such as flavors, colors, flavor suppressants, flavor maskers, colors, fruit powders, fruit concentrates, fruit flavors, spices, spice oils, sweeteners, sugars, syrups, salts, polyols, whiteners, titanium dioxide, and/or combinations thereof. In some implementations, the preconditioner may be heated to a range of 25-100° C.

As shown in reference number 108, after the preconditioner preconditions the mixture of non-soy, legume, protein and carbohydrate products to form the legume, protein, pre-extrudate product, the legume, protein, pre-extrudate product may be fed into an extruder to extrude the legume, protein, pre-extrudate product to form the legume, protein, extrudate product. The extruder may house two primary components: a housing barrel and at least one inner screw. The space between the at least one inner screw and the housing barrel can house legume, protein, pre-extrudate product to be extruded. In some implementations, there can be an outer cylinder encasing the housing barrel which may be filled with either oil, water, steam, or combinations thereof to heat the housing barrel. The at least one inner screw may comprise various removable, adjustable, and/or customizable screw elements for conveying the material (conveying element), mixing and/or compressing the legume, protein, pre-extrudate product (kneading blocks), and shearing the legume, protein, pre-extrudate product (shearing elements). In some implementations, the at least one inner screw is a singular screw. In some implementations, the at least one inner screw is two screws. In some implementations, the at least one inner screw is three or more screws. The conveying element of the at least one inner screw can carry the legume, protein, pre-extrudate product along the at least one inner screw either forward (away from where the material entered the extruder) or backward (toward the point where the legume, protein, pre-extrudate product entered the extruder).

The kneading blocks can help shape the legume, protein, pre-extrudate product by further mixing it, compressing it, kneading it, rolling it, tumbling it, and/or assisting in the conveying of it. The shearing elements may be various elements of the at least one inner screw that assist in shaping the legume, protein, pre-extrudate product (through cutting, shearing, grinding, and/or shredding) as it passes through the extruder. The shearing elements may comprise various grooves and/or protrusions along the at least one inner screw or may comprise typical screw elements in a perpendicular arrangement to the at least one inner screw or combinations thereof. In some implementations, some of the shearing elements may be reversed to align the protein fibers. The various elements of the at least one inner screw may or may not be uniform, and can be customized along the at least one inner screw to adjust for pitch, flight height, axial flight width, number of flights, height depth, helix angle, depth of protrusions and grooves, etc.

The extruder may comprise four primary zones along the housing barrel and the at least one inner screw: a conveying zone (25-80° C.), a mixing zone (25-95° C.), a cooking zone (80-140° C.), and a final treatment zone (110-150° C.). The conveying zone may comprise conveying elements that move the legume, protein, pre-extrudate product along one pitch length. The mixing zone may comprise of kneading blocks and may allow for the addition of water and oils into the legume, protein, pre-extrudate product. The mixing zone may comprise reverse elements which may increase the length of mixing time. The cooking zone may comprise larger kneading blocks as well as shearing elements. The cooking zone may also the point at which the legume, protein, pre-extrudate product may also be heated to a desired temperature. The final treatment zone may perform the actions of the prior three zones in one final section of the extruder. After leaving the final treatment zone, the legume, protein, pre-extrudate product exits the extruder, is transformed into the legume, protein, extrudate product, and can enter a cooling die.

The cooling die may be rectangular and/or flat in shape with either rounded or sharp corners. The legume, protein, extrudate product can be fibrous and the fibers in the, legume, protein, extrudate product can be aligned with the cooling die and create laminar flow at the beginning of the cooling die. The bonds of the legume, protein, extrudate product may be reformed into di-sulfide bonds and/or other inter-molecular bonds. As the legume, protein, extrudate product is fed into the cooling die, the legume, protein, extrudate product may be stretched along the surface of the die due to contact friction. This can create an uneven flow between the center of the material and the material along the walls of the die. The length of the cooling die may be selected for the desired length of the legume, protein, extrudate product. As the legume, protein, extrudate product fills up the cooling die, cooled water and/or oil can be circulated along the die's outer walls, which in turn may cool the legume, protein, extrudate product. The legume, protein, extrudate product can be cooled to a temperature less than about 105° C. The resulting legume, protein, extrudate product may comprise a density between 0.8 g/cm³ to about 3 g/cm³.

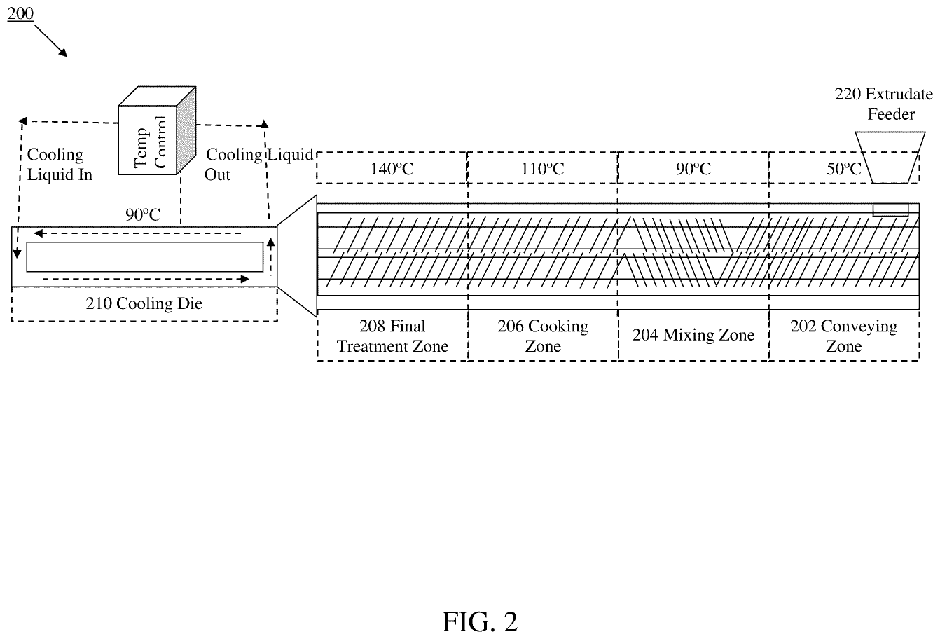

FIG. 2 is an illustrative example of the extruder 200. Example extruder 200 may comprise an extrudate feeder 220, a conveying zone 202, a mixing zone 204, a cooking zone 206, a final treatment zone 210, and a cooling die 210. In this example, the legume, protein, pre-extrudate product enters the extrudate feeder 220 which feeds the legume, protein, pre-extrudate product into the housing barrel comprising two inner screws. The legume, protein, pre-extrudate product, water, and/or oil enter the conveying zone 202 which is set to a temperature between 40° C. and 70° ° C. The legume, protein, pre-extrudate product is transported to the mixing zone 204 by the two inner screws. The legume, protein, pre-extrudate product enter the mixing zone 204 which is set to a temperature between 90° C. and comprises reverse screw elements. The legume, protein, pre-extrudate product is transported to the cooking zone 206 by the two inner screws. The legume, protein, pre-extrudate product enter the cooking zone 206 which is set to a temperature between 110° C. The legume, protein, pre-extrudate product is transported to the final treatment zone 208 by the two inner screws. The legume, protein, pre-extrudate product can enter the final treatment zone 208 which can be set to a temperature between 120° C. and 165° C. The legume, protein, pre-extrudate product then exits the extruder's housing barrel and is transformed into the legume, protein, extrudate product. The legume, protein, extrudate product can enter the cooling die 210 which can be set to a temperature of 60° C. to 105° C. The cooling die can be cooled by having water pass through its outer casing and cycling through to a temperature control device to remove excess heat. The legume, protein, extrudate product can be stretched along the walls of the cooling die as it moves through and exits the cooling die and is transformed into the processed extrudate product.

As shown in reference numeral 110, after the extruder extrudes the legume, protein, pre-extrudate product, the processor may process the legume, protein, extrudate product to form the processed extrudate product. The processor may shear, cut, chop, shred, grind, compress, knead, roll, tumble, tenderize, reduce, boil, broil, grill, fry, roast, bake, smoke, steam, dehydrate, pickle, marinate, and/or freeze dry the legume, protein, extrudate product to form the processed extrudate product.

As shown in reference numeral 112, after the processor processes the legume, protein, extrudate product and forms the processed extrudate product, the injector may inject the processed extrudate product with various ingredients or substances, such as flavors, colors, flavor suppressants, flavor maskers, colors, fruit powders, fruit concentrates, fruit flavors, spices, spice oils, sweeteners, sugars, syrups, salts, polyols, whiteners, and/or titanium dioxide to form the flavored processed extrudate product. In some implementations, the foregoing ingredients may be added to the mixer, the preconditioner, and/or the extruder in addition to and/or alternatively to the injector.

As shown in reference numeral 114, after the injector injects the processed extrudate product with one or more ingredients to form a flavored processed extrudate product, the cooler may cool the flavored processed extrudate product to a temperature of less than or equal to 25° C. In some implementations, the cooler may cool the legume, protein, extrudate product to a temperature range of at most 25° C. In some other implementations, the cooler may cool the legume, protein, extrudate product to a temperature range of −40-0° C. Cooling the flavored processed extrudate product transforms the flavored processed extrudate product into the final food product.

As shown in reference numeral 116, after the cooler cools the flavored processed extrudate product and forms the final food product, the packer may package the final food product for shipping and distribution. The packer may be an automated device (e.g., an assembly packer), a person operating common packing devices (e.g., placing the final food product into packaging, placing the packaged final food product into a box, filling the box with packing material, and sealing the box with packing tape), and/or the like.

The legume, protein, extrudate product, processed extrudate product, flavored processed extrudate product, and/or final food product, prior to packaging, may be further manipulated and/or shaped into a food product that may resemble cooked meat that is comparable to cooked fowl food products (e.g., cooked chicken breasts, cooked chicken nuggets, cooked chicken tenders, cooked chicken fajitas, cooked turkey breasts, cooked chicken jerky, cooked chicken sausages, cooked deli meat—such as sliced, cooked turkey breast, loafed, cooked turkey breast, etc.—and/or the like), cooked cattle food products (e.g., cooked shredded beef steak, cooked veil, cooked beef steak, cooked burger patties, and/or the like), cooked swine food products (e.g., cooked pork chops, cooked American bacon, cooked Canadian bacon, cooked ham steak, cooked, sliced ham, cooked pork sausages, and/or the like), cooked ovine food products (e.g., cooked lamb chops, cooked mutton, cooked lamb shanks, cooked lamb loins, and/or the like), and/or combinations thereof (e.g., beef-pork sausages, pepperoni, salami, hot dogs, and/or the like) in terms of appearance, consistency, texture, and taste.

TABLE 1

| Attributes | Units | Protein A | Protein B | Protein C | Protein D |
|---|---|---|---|---|---|
| pH | (Unitless) | 6.5-7.5 | 5.5-6.5 | 7-7.5 | 7.2-7.8 |
| Protein | % | 21-75 | 10-20 | No data | No data |
| Solubility | | | | | |
| Gelation | g force | 21.30 | 0 | 0 | No data |
| Water | g H₂O/g | minimum 3.5 | <3.0 | minimum 3.5 | minimum 4 |
| Hydration | Protein | | | | |
| Bostwick | cm/s | 0.7 cm/s | No data | No data | No data |
| PDI | % | 82.9 | 2.2 | No data | 48.10 |
| Sedimentation | mL | No data | No data | No data | No data |
| NSI | % | 29.94 | 12.14 | No data | 18.10 |
| Protein | % | ~80 | ~80 | ~80 | ~80 |
| Content | | | | | |
| Oil Binding | g Oil/g | 0.870 | 1.14 | 0.983 | No data |
| | Protein | | | | |
| Emulsification | g/g | 203.2 | 139.3 | 142.30 | No data |
| Capacity | Protein | | | | |
| Foaming | g/mL | 140 | 0 | 96 | No data |
| Capacity | | | | | |
| Foaming | % | 71.40 | 0 | 90 | No data |
| Stability | | | | | |
| Water Holding | % | 99.80 | 0 (No gel) | 0 (No gel) | No data |
| Capacity | | | | | |
| Bulk Density | g/L | 347 | 450 | 350 | 350 |
| Brookfield | cPs | 60 | No data | No data | No data |
| Viscosity | | | | | |
| Viscosity | cP | 1032.5 | 380.5 | 791.5 | No data |
| from PPT | | | | | |
| (not heated) | | | | | |
| Viscosity | cP | 561.4 | 185.2 | 298.4 | No data |
| from PPT | | | | | |
| (heated) | | | | | |
| Color | L, a, b | 84.50, 3.15, 28.97 | 86.16, 2.73, 26.60 | 87.39, 1.76, 22.51 | No data |

| Attributes | Protein E | Protein F | Protein G | | Protein H |
|---|---|---|---|---|---|
| pH | 6.5-7.5 | 6.5-7.5 | 6.5-7.5 | | 7-7.5 |
| Protein | No data | 40-55% | No data | | No data |
| Solubility | | | | | |
| Gelation | No data | 0 | No data | | No data |
| Water | Minimum 3.5 | <2.4 | 2.4-2.9 | | minimum 3.5 |
| Hydration | | | | | |
| Bostwick | No data | No data | No data | | No data |
| PDI | No data | No data | No data | | No data |
| Sedimentation | No data | No data | No data | | No data |
| NSI | No data | No data | No data | | No data |
| Protein | ~80% | ~80% | ~80% | | ~80% |
| Content | | | | | |
| Oil Binding | No data | 0.8 | 0.816 | | 1.6-2.6 |
| Emulsification | No data | 673.80 g/g | 405.20 g/g | | No data |
| Capacity | | protein | data | | |
| Foaming | No data | 0 | 376 | g/mL | No data |
| Capacity | | | | | |
| Foaming | No data | 0 | 47% | | No data |
| Stability | | | | | |
| Water Holding | No data | No gel (0) | 20.00% | | No data |
| Capacity | | | | | |
| Bulk Density | No data | 450 g/L | 450 | g/L | Haven't found yet |

| | | | | |
|---|---|---|---|---|
| Brookfield | No data | No data | No data | No data |
| Viscosity | | | | |
| Viscosity | No data | 65.7 | 279.1 | No data |
| from PPT | | | | |
| (not heated) | | | | |
| Viscosity | No data | 63.7 | 106.9 | No data |
| from PPT | | | | |
| (heated) | | | | |
| Color | No data | 84.45, 3.12, 27.40 | 78.00, 2.42, 24.12 | No data |

TABLE 2

| | | | | | | | | | Stable | Product |
|---|---|---|---|---|---|---|---|---|---|---|
| Protein | A | B | C | D | E | F | G | H | product? | Characteristics |
| Example | 100 | 0 | 0 | 0 | 0 | 0 | 0 | 0 | No | Very mushy. Not |
| 1 | | | | | | | | | | likely to combine |
| | | | | | | | | | | together and form |
| | | | | | | | | | | fibers |
| Example | 0 | 100 | 0 | 0 | 0 | 0 | 0 | 0 | Yes | Very strong. Possibly |
| 2 | | | | | | | | | | too strong for some |
| | | | | | | | | | | applications |
| Example | 0 | 0 | 100 | 0 | 0 | 0 | 0 | 0 | Yes | Soft and stretchy. |
| 3 | | | | | | | | | | Forms more flakes and |
| | | | | | | | | | | less fibers. |
| Example | 0 | 0 | 0 | 100 | 0 | 0 | 0 | 0 | Yes/Somewhat | Does not work perfect |
| 4 | | | | | | | | | | by itself and adding a |
| | | | | | | | | | | small amount of |
| | | | | | | | | | | Protein B helps make |
| | | | | | | | | | | this product work |
| Example | 0 | 0 | 0 | 0 | 100 | 0 | 0 | 0 | Unknown | Has not yet been tested |
| 5 | | | | | | | | | | |
| Example | 0 | 0 | 0 | 0 | 0 | 100 | 0 | 0 | Unknown | Has not yet been tested |
| 6 | | | | | | | | | | |
| Example | 0 | 0 | 0 | 0 | 0 | 0 | 100 | 0 | Unknown | Has not yet been tested |
| 7 | | | | | | | | | | |
| Example | 0 | 0 | 0 | 0 | 0 | 0 | 0 | 100 | Yes | Very similar to Protein |
| 8 | | | | | | | | | | C. The agglomerated |
| | | | | | | | | | | product absorbs water |
| | | | | | | | | | | much faster than non- |
| | | | | | | | | | | agglomerated. This |
| | | | | | | | | | | property is only found |
| | | | | | | | | | | in the raw material and |
| | | | | | | | | | | not the final product. |
| Example | 75 | 25 | 0 | 0 | 0 | 0 | 0 | 0 | No | Very soft and not |
| 9 | | | | | | | | | | stable at production |
| | | | | | | | | | | rates/scale. The HME |
| | | | | | | | | | | is not homogenous in |
| | | | | | | | | | | filament formation. |
| | | | | | | | | | | The inside core of the |
| | | | | | | | | | | product creates |
| | | | | | | | | | | stronger filaments than |
| | | | | | | | | | | the outside. A |
| | | | | | | | | | | somewhat decent |
| | | | | | | | | | | product can be made at |
| | | | | | | | | | | pilot scale that is very |
| | | | | | | | | | | pliable while hot but |
| | | | | | | | | | | easily broken once |
| | | | | | | | | | | cold. More than 25% |
| | | | | | | | | | | Protein B is needed in |
| | | | | | | | | | | combination with |
| | | | | | | | | | | Protein A to create a |
| | | | | | | | | | | stable and desirable |
| | | | | | | | | | | product. |
| Example | 75 | 0 | 25 | 0 | 0 | 0 | 0 | 0 | No | Protein C by itself can |
| 10 | | | | | | | | | | create a product with |
| | | | | | | | | | | acceptable texture, but |
| | | | | | | | | | | at 25% there is not |
| | | | | | | | | | | enough strength to this |
| | | | | | | | | | | product. As such, |
| | | | | | | | | | | product becomes very |
| | | | | | | | | | | soft and mushy. The |
| | | | | | | | | | | product can be |
| | | | | | | | | | | compressed and balled |
| | | | | | | | | | | into a dough instead of |
| | | | | | | | | | | being pulled apart into |
| | | | | | | | | | | fibers. |
| Example | 75 | 0 | 0 | 25 | 0 | 0 | 0 | 0 | No | Neither Protein A or |
| 11 | | | | | | | | | | Protein D make good |
| | | | | | | | | | | products by themselves |
| | | | | | | | | | | and no combination of |
| | | | | | | | | | | A and D result in a |
| | | | | | | | | | | stable product. The |
| | | | | | | | | | | product would however |
| | | | | | | | | | | be stronger than |
| | | | | | | | | | | Proteins A and D |
| | | | | | | | | | | alone. |
| Example | 75 | 0 | 0 | 0 | 25 | 0 | 0 | 0 | Unknown | It is possible that this |
| 12 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this stage, |
| | | | | | | | | | | not enough evidence to |
| | | | | | | | | | | say. |
| Example | 75 | 0 | 0 | 0 | 0 | 25 | 0 | 0 | Unknown | It is possible that this |
| 13 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein A. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| Example | 75 | 0 | 0 | 0 | 0 | 0 | 25 | 0 | Unknown | It is possible that this |
| 14 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein A. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. |
| Example | 75 | 0 | 0 | 0 | 0 | 0 | 0 | 25 | No | Protein H by itself can |
| 15 | | | | | | | | | | create a product with |
| | | | | | | | | | | acceptable texture, but |
| | | | | | | | | | | at 25% there is not |
| | | | | | | | | | | enough strength to this |
| | | | | | | | | | | product. As such, |
| | | | | | | | | | | product becomes very |
| | | | | | | | | | | soft and mushy. The |
| | | | | | | | | | | product can be |
| | | | | | | | | | | compressed and balled |
| | | | | | | | | | | into a dough instead of |
| | | | | | | | | | | being pulled apart into |
| | | | | | | | | | | fibers. |
| Example | 50 | 50 | 0 | 0 | 0 | 0 | 0 | 0 | Yes | This makes a very |
| 16 | | | | | | | | | | good HME product that |
| | | | | | | | | | | has a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. At larger scales |
| | | | | | | | | | | this recipe still works |
| | | | | | | | | | | but a higher level of |
| | | | | | | | | | | Protein B has been |
| | | | | | | | | | | found to be more ideal. |
| | | | | | | | | | | This is because leaving |
| | | | | | | | | | | a larger cooling die |
| | | | | | | | | | | there are more shear |
| | | | | | | | | | | forces pulling on the |
| | | | | | | | | | | product because of its |
| | | | | | | | | | | own weight that causes |
| | | | | | | | | | | uneven flow and more |
| | | | | | | | | | | tearing of the HME |
| | | | | | | | | | | sheets. |
| Example | 50 | 0 | 50 | 0 | 0 | 0 | 0 | 0 | No | Protein C by itself can |
| 17 | | | | | | | | | | create a product with |
| | | | | | | | | | | acceptable texture, but |
| | | | | | | | | | | at 50% there is not |
| | | | | | | | | | | enough strength to this |
| | | | | | | | | | | product. As such, |
| | | | | | | | | | | product becomes very |
| | | | | | | | | | | soft and mushy. The |
| | | | | | | | | | | product can be |
| | | | | | | | | | | compressed and balled |
| | | | | | | | | | | into a dough instead of |
| | | | | | | | | | | being pulled apart into |
| | | | | | | | | | | fibers. The product |
| | | | | | | | | | | would be more resilient |
| | | | | | | | | | | than example 10 but |
| | | | | | | | | | | still not resilient |
| | | | | | | | | | | enough to resemble |
| | | | | | | | | | | meat. |
| Example | 50 | 0 | 0 | 50 | 0 | 0 | 0 | 0 | No | Neither Protein A or |
| 18 | | | | | | | | | | Protein D make good |
| | | | | | | | | | | products by themselves |
| | | | | | | | | | | and no combination of |
| | | | | | | | | | | A and D result in a |
| | | | | | | | | | | stable product. The |
| | | | | | | | | | | product would however |
| | | | | | | | | | | be stronger than |
| | | | | | | | | | | Proteins A and D |
| | | | | | | | | | | alone. |
| Example | 50 | 0 | 0 | 0 | 50 | 0 | 0 | 0 | Unknown | It is possible that this |
| 19 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this stage, |
| | | | | | | | | | | not enough evidence to |
| | | | | | | | | | | say. |
| Example | 50 | 0 | 0 | 0 | 0 | 50 | 0 | 0 | Unknown | It is possible that this |
| 20 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein A. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| Example | 50 | 0 | 0 | 0 | 0 | 0 | 50 | 0 | Unknown | It is possible that this |
| 21 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein A. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. |
| Example | 50 | 0 | 0 | 0 | 0 | 0 | 0 | 50 | No | Protein H by itself can |
| 22 | | | | | | | | | | create a product with |
| | | | | | | | | | | acceptable texture, but |
| | | | | | | | | | | at 50% there is not |
| | | | | | | | | | | enough strength to this |
| | | | | | | | | | | product. As such, |
| | | | | | | | | | | product becomes very |
| | | | | | | | | | | soft and mushy. The |
| | | | | | | | | | | product can be |
| | | | | | | | | | | compressed and balled |
| | | | | | | | | | | into a dough instead of |
| | | | | | | | | | | being pulled apart into |
| | | | | | | | | | | fibers. The product |
| | | | | | | | | | | would be more resilient |
| | | | | | | | | | | than example 15 but |
| | | | | | | | | | | still not resilient |
| | | | | | | | | | | enough to resemble |
| | | | | | | | | | | meat. |
| Example | 25 | 75 | 0 | 0 | 0 | 0 | 0 | 0 | Yes | This makes a very |
| 23 | | | | | | | | | | good HME product that |
| | | | | | | | | | | has a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. This combination |
| | | | | | | | | | | has been found to be |
| | | | | | | | | | | highly ideal for chicken |
| | | | | | | | | | | type products but could |
| | | | | | | | | | | also be used for other |
| | | | | | | | | | | animal substitutes. This |
| | | | | | | | | | | sample has integrity to |
| | | | | | | | | | | withstand full scale |
| | | | | | | | | | | production. Protein B |
| | | | | | | | | | | provides enough |
| | | | | | | | | | | resilience and great |
| | | | | | | | | | | filament development |
| | | | | | | | | | | while Protein A |
| | | | | | | | | | | ensures the product is |
| | | | | | | | | | | still soft and malleable. |
| Example | 25 | 0 | 75 | 0 | 0 | 0 | 0 | 0 | Somewhat | Protein C by itself can |
| 24 | | | | | | | | | | create a product with |
| | | | | | | | | | | acceptable texture, at |
| | | | | | | | | | | 75% there is almost |
| | | | | | | | | | | enough strength to this |
| | | | | | | | | | | product. But the |
| | | | | | | | | | | product is still very soft |
| | | | | | | | | | | and mushy. The |
| | | | | | | | | | | product would have |
| | | | | | | | | | | some fibers that could |
| | | | | | | | | | | be separated but likely |
| | | | | | | | | | | be softer than |
| | | | | | | | | | | combinations of |
| | | | | | | | | | | Proteins A and B. The |
| | | | | | | | | | | product would be more |
| | | | | | | | | | | resilient than example |
| | | | | | | | | | | 10 or example 17. |
| Example | 25 | 0 | 0 | 75 | 0 | 0 | 0 | 0 | No | Neither Protein A or |
| 25 | | | | | | | | | | Protein D make good |
| | | | | | | | | | | products by themselves |
| | | | | | | | | | | and no combination of |
| | | | | | | | | | | A and D result in a |
| | | | | | | | | | | stable product. The |
| | | | | | | | | | | product would however |
| | | | | | | | | | | be stronger than |
| | | | | | | | | | | Proteins A and D |
| | | | | | | | | | | alone. |
| Example | 25 | 0 | 0 | 0 | 75 | 0 | 0 | 0 | Unknown | It is possible that this |
| 26 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. |
| Example | 25 | 0 | 0 | 0 | 0 | 75 | 0 | 0 | Unknown | It is possible that this |
| 27 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein A. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| Example | 25 | 0 | 0 | 0 | 0 | 0 | 75 | 0 | Unknown | It is possible that this |
| 28 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein A. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. |
| Example | 25 | 0 | 0 | 0 | 0 | 0 | 0 | 75 | Unknown | Protein H by itself can |
| 29 | | | | | | | | | | create a product with |
| | | | | | | | | | | acceptable texture, at |
| | | | | | | | | | | 75% there is almost |
| | | | | | | | | | | enough strength to this |
| | | | | | | | | | | product. But the |
| | | | | | | | | | | product is still very soft |
| | | | | | | | | | | and mushy. The |
| | | | | | | | | | | product would have |
| | | | | | | | | | | some fibers that could |
| | | | | | | | | | | be separated but likely |
| | | | | | | | | | | be softer than |
| | | | | | | | | | | combinations of |
| | | | | | | | | | | Proteins A and B. The |
| | | | | | | | | | | product would be more |
| | | | | | | | | | | resilient than example |
| | | | | | | | | | | 15 or example 22. |
| Example | 0 | 75 | 25 | 0 | 0 | 0 | 0 | 0 | Yes | This makes a very |
| 30 | | | | | | | | | | good HME product that |
| | | | | | | | | | | has a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. This example |
| | | | | | | | | | | tends to be more |
| | | | | | | | | | | stretchy and elastic |
| | | | | | | | | | | than example 23. This |
| | | | | | | | | | | combination has been |
| | | | | | | | | | | found to be highly |
| | | | | | | | | | | ideal for chicken type |
| | | | | | | | | | | products but could also |
| | | | | | | | | | | be used for other |
| | | | | | | | | | | animal substitutes. This |
| | | | | | | | | | | sample has integrity to |
| | | | | | | | | | | withstand full scale |
| | | | | | | | | | | production. Protein B |
| | | | | | | | | | | provides enough |
| | | | | | | | | | | resilience and great |
| | | | | | | | | | | filament development |
| | | | | | | | | | | while Protein C ensures |
| | | | | | | | | | | the product is still soft |
| | | | | | | | | | | and malleable. |
| Example | 0 | 75 | 0 | 25 | 0 | 0 | 0 | 0 | Yes | This makes a very |
| 31 | | | | | | | | | | good HME product that |
| | | | | | | | | | | has a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. This combination |
| | | | | | | | | | | has been found to be |
| | | | | | | | | | | highly ideal (most ideal |
| | | | | | | | | | | of all combinations so |
| | | | | | | | | | | far for Protein B and |
| | | | | | | | | | | Protein D) for chicken |
| | | | | | | | | | | type products but could |
| | | | | | | | | | | also be used for other |
| | | | | | | | | | | animal substitutes. This |
| | | | | | | | | | | sample has integrity to |
| | | | | | | | | | | withstand full scale |
| | | | | | | | | | | production. Protein B |
| | | | | | | | | | | provides enough |
| | | | | | | | | | | resilience and great |
| | | | | | | | | | | filament development |
| | | | | | | | | | | while Protein D |
| | | | | | | | | | | ensures the product is |
| | | | | | | | | | | still soft and malleable |
| | | | | | | | | | | while gelling and |
| | | | | | | | | | | ensuring even flow |
| | | | | | | | | | | through a cooling die |
| | | | | | | | | | | system |
| Example | 0 | 75 | 0 | 0 | 25 | 0 | 0 | 0 | Unknown | It is possible that this |
| 32 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. |
| | | | | | | | | | | However, given the |
| | | | | | | | | | | high level of Protein B |
| | | | | | | | | | | this is likely to still |
| | | | | | | | | | | make an acceptable |
| | | | | | | | | | | product. |
| Example | 0 | 75 | 10 | 0 | 0 | 25 | 0 | 0 | Unknown | It is possible that this |
| 33 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein B. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| | | | | | | | | | | However, given the |
| | | | | | | | | | | high level of Protein B |
| | | | | | | | | | | this is likely to still |
| | | | | | | | | | | make an acceptable |
| | | | | | | | | | | product. |
| Example | 0 | 75 | 0 | 0 | 0 | 0 | 25 | 0 | Unknown | It is possible that this |
| 34 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein B. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. |
| | | | | | | | | | | However, given the |
| | | | | | | | | | | high level of Protein B |
| | | | | | | | | | | this is likely to still |
| | | | | | | | | | | make an acceptable |
| | | | | | | | | | | product. |
| Example | 0 | 75 | 0 | 0 | 0 | 0 | 0 | 25 | Yes | This makes a very |
| 35 | | | | | | | | | | good HME product that |
| | | | | | | | | | | has a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. This example |
| | | | | | | | | | | tends to be more |
| | | | | | | | | | | stretchy and elastic |
| | | | | | | | | | | than example 23. This |
| | | | | | | | | | | combination has been |
| | | | | | | | | | | found to be highly |
| | | | | | | | | | | ideal for chicken type |
| | | | | | | | | | | products but could also |
| | | | | | | | | | | be used for other |
| | | | | | | | | | | animal substitutes. This |
| | | | | | | | | | | sample has integrity to |
| | | | | | | | | | | withstand full scale |
| | | | | | | | | | | production. Protein B |
| | | | | | | | | | | provides enough |
| | | | | | | | | | | resilience and great |
| | | | | | | | | | | filament development |
| | | | | | | | | | | while Protein H |
| | | | | | | | | | | ensures the product is |
| | | | | | | | | | | still soft and malleable. |
| Example | 0 | 50 | 50 | 0 | 0 | 0 | 0 | 0 | Yes | This makes a good |
| 36 | | | | | | | | | | HME product that has |
| | | | | | | | | | | a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. The higher level |
| | | | | | | | | | | of Protein C than |
| | | | | | | | | | | example 30 will cause |
| | | | | | | | | | | this product to be |
| | | | | | | | | | | softer. This example |
| | | | | | | | | | | tends to be more |
| | | | | | | | | | | stretchy and elastic |
| | | | | | | | | | | than example 30. This |
| | | | | | | | | | | combination has been |
| | | | | | | | | | | found to be highly |
| | | | | | | | | | | ideal for chicken type |
| | | | | | | | | | | products but could also |
| | | | | | | | | | | be used for other |
| | | | | | | | | | | animal substitutes. This |
| | | | | | | | | | | sample has integrity to |
| | | | | | | | | | | withstand full scale |
| | | | | | | | | | | production. Protein B |
| | | | | | | | | | | provides enough |
| | | | | | | | | | | resilience and great |
| | | | | | | | | | | filament development |
| | | | | | | | | | | while Protein C ensures |
| | | | | | | | | | | the product is still soft |
| | | | | | | | | | | and malleable. |
| Example | 0 | 50 | 0 | 50 | 0 | 0 | 0 | 0 | Yes | This makes a very |
| 37 | | | | | | | | | | good HME product that |
| | | | | | | | | | | has a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. This combination |
| | | | | | | | | | | has been found to be |
| | | | | | | | | | | highly ideal (not as |
| | | | | | | | | | | ideal as example 31) |
| | | | | | | | | | | for chicken type |
| | | | | | | | | | | products but could also |
| | | | | | | | | | | be used for other |
| | | | | | | | | | | animal substitutes. This |
| | | | | | | | | | | sample has integrity to |
| | | | | | | | | | | withstand full scale |
| | | | | | | | | | | production. Protein B |
| | | | | | | | | | | provides enough |
| | | | | | | | | | | resilience and great |
| | | | | | | | | | | filament development |
| | | | | | | | | | | while Protein D |
| | | | | | | | | | | ensures the product is |
| | | | | | | | | | | still soft and malleable |
| | | | | | | | | | | while gelling and |
| | | | | | | | | | | ensuring even flow |
| | | | | | | | | | | through a cooling die |
| | | | | | | | | | | system. This |
| | | | | | | | | | | combination has some |
| | | | | | | | | | | issues with flow out of |
| | | | | | | | | | | the cooling die but can |
| | | | | | | | | | | still be considered |
| | | | | | | | | | | acceptable. |
| Example | 0 | 50 | 0 | 0 | 50 | 0 | 0 | 0 | Unknown | It is possible that this |
| 38 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. |
| | | | | | | | | | | However, given the |
| | | | | | | | | | | high level of Protein B |
| | | | | | | | | | | this is somewhat likely |
| | | | | | | | | | | to still make an |
| | | | | | | | | | | acceptable product. |
| Example | 0 | 50 | 0 | 0 | 0 | 50 | 0 | 0 | Unknown | It is possible that this |
| 39 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein B. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| | | | | | | | | | | However, given the |
| | | | | | | | | | | high level of Protein B |
| | | | | | | | | | | this is somewhat likely |
| | | | | | | | | | | to still make an |
| | | | | | | | | | | acceptable product. |
| Example | 0 | 50 | 0 | 0 | 0 | 0 | 50 | 0 | Unknown | It is possible that this |
| 40 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein B. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. |
| | | | | | | | | | | However, given the |
| | | | | | | | | | | high level of Protein B |
| | | | | | | | | | | this is somewhat likely |
| | | | | | | | | | | to still make an |
| | | | | | | | | | | acceptable product. |
| Example | 0 | 50 | 0 | 0 | 0 | 0 | 0 | 50 | Yes | This makes a good |
| 41 | | | | | | | | | | HME product that has |
| | | | | | | | | | | a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. The higher level |
| | | | | | | | | | | of Protein H than |
| | | | | | | | | | | example 34 will cause |
| | | | | | | | | | | this product to be |
| | | | | | | | | | | softer. This example |
| | | | | | | | | | | tends to be more |
| | | | | | | | | | | stretchy and elastic |
| | | | | | | | | | | than example 30. This |
| | | | | | | | | | | combination has been |
| | | | | | | | | | | found to be highly |
| | | | | | | | | | | ideal for chicken type |
| | | | | | | | | | | products but could also |
| | | | | | | | | | | be used for other |
| | | | | | | | | | | animal substitutes. This |
| | | | | | | | | | | sample has integrity to |
| | | | | | | | | | | withstand full scale |
| | | | | | | | | | | production. Protein B |
| | | | | | | | | | | provides enough |
| | | | | | | | | | | resilience and great |
| | | | | | | | | | | filament development |
| | | | | | | | | | | while Protein H |
| | | | | | | | | | | ensures the product is |
| | | | | | | | | | | still soft and malleable. |
| Example | 0 | 25 | 75 | 0 | 0 | 0 | 0 | 0 | Yes | This makes a good |
| 42 | | | | | | | | | | HME product that has |
| | | | | | | | | | | a good balance |
| | | | | | | | | | | between an elastic pull |
| | | | | | | | | | | while still having a |
| | | | | | | | | | | resistance filament |
| | | | | | | | | | | structure that will tear |
| | | | | | | | | | | apart like meat. The |
| | | | | | | | | | | higher level of Protein |
| | | | | | | | | | | C than example 36 will |
| | | | | | | | | | | cause this product to be |
| | | | | | | | | | | softer. This example |
| | | | | | | | | | | tends to be more |
| | | | | | | | | | | stretchy and elastic |
| | | | | | | | | | | than example 36. This |
| | | | | | | | | | | combination has been |
| | | | | | | | | | | found to be ideal for |
| | | | | | | | | | | chicken type products |
| | | | | | | | | | | but could also be used |
| | | | | | | | | | | for other animal |
| | | | | | | | | | | substitutes could be |
| | | | | | | | | | | more similar to Pork. |
| | | | | | | | | | | Protein B provides |
| | | | | | | | | | | enough resilience and |
| | | | | | | | | | | great filament |
| | | | | | | | | | | development while |
| | | | | | | | | | | Protein C ensures the |
| | | | | | | | | | | product is still soft and |
| | | | | | | | | | | malleable. This product |
| | | | | | | | | | | will pull apart in more |
| | | | | | | | | | | think layers like sheets |
| | | | | | | | | | | rather than thin |
| | | | | | | | | | | filaments. |
| Example | 0 | 25 | 0 | 75 | 0 | 0 | 0 | 0 | Yes | This makes a decent |
| 43 | | | | | | | | | | HME product that is a |
| | | | | | | | | | | bit on the softer side. |
| | | | | | | | | | | There is not enough of |
| | | | | | | | | | | Protein B in this |
| | | | | | | | | | | example to achieve a |
| | | | | | | | | | | great product that will |
| | | | | | | | | | | process evenly. This |
| | | | | | | | | | | product creates |
| | | | | | | | | | | filaments but can fall |
| | | | | | | | | | | apart to easily |
| Example | 0 | 25 | 0 | 0 | 75 | 0 | 0 | 0 | Unknown | It is possible that this |
| 44 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. If |
| | | | | | | | | | | Protein E does not |
| | | | | | | | | | | provide much |
| | | | | | | | | | | functionality, then |
| | | | | | | | | | | there is likely not |
| | | | | | | | | | | enough of Protein B to |
| | | | | | | | | | | make an acceptable |
| | | | | | | | | | | product. |
| Example | 0 | 25 | 0 | 0 | 0 | 75 | 0 | 0 | Unknown | It is possible that this |
| 45 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein B. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. If |
| | | | | | | | | | | Protein F does not |
| | | | | | | | | | | provide much |
| | | | | | | | | | | functionality, then |
| | | | | | | | | | | there is likely not |
| | | | | | | | | | | enough of Protein B to |
| | | | | | | | | | | make an acceptable |
| | | | | | | | | | | product. |
| Example | 0 | 25 | 0 | 0 | 0 | 0 | 75 | 0 | Unknown | It is possible that this |
| 46 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein B. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. If |
| | | | | | | | | | | Protein G does not |
| | | | | | | | | | | provide much |
| | | | | | | | | | | functionality, then |
| | | | | | | | | | | there is likely not |
| | | | | | | | | | | enough of Protein B to |
| | | | | | | | | | | make an acceptable |
| | | | | | | | | | | product. |
| Example | 0 | 25 | 0 | 0 | 0 | 0 | 0 | 75 | Yes | This makes a good |
| 47 | | | | | | | | | | HME product that has |
| | | | | | | | | | | a good balance |
| | | | | | | | | | | between a soft and |
| | | | | | | | | | | elastic pull while still |
| | | | | | | | | | | having a resistance |
| | | | | | | | | | | filament structure that |
| | | | | | | | | | | will tear apart like |
| | | | | | | | | | | meat. The higher level |
| | | | | | | | | | | of Protein H than |
| | | | | | | | | | | example 41 will cause |
| | | | | | | | | | | this product to be |
| | | | | | | | | | | softer. This example |
| | | | | | | | | | | tends to be more |
| | | | | | | | | | | stretchy and elastic |
| | | | | | | | | | | than example 41. This |
| | | | | | | | | | | combination has been |
| | | | | | | | | | | found to be ideal for |
| | | | | | | | | | | chicken type products |
| | | | | | | | | | | but could also be used |
| | | | | | | | | | | for other animal |
| | | | | | | | | | | substitutes. Protein B |
| | | | | | | | | | | provides enough |
| | | | | | | | | | | resilience and great |
| | | | | | | | | | | filament development |
| | | | | | | | | | | while Protein H |
| | | | | | | | | | | ensures the product is |
| | | | | | | | | | | still soft and malleable. |
| | | | | | | | | | | This product will pull |
| | | | | | | | | | | apart in more think |
| | | | | | | | | | | layers like sheets rather |
| | | | | | | | | | | than thin filaments. |
| Example | 0 | 0 | 75 | 25 | 0 | 0 | 0 | 0 | Somewhat | Too soft and pliable. |
| 48 | | | | | | | | | | Does not have an |
| | | | | | | | | | | acceptable pull apart |
| | | | | | | | | | | texture. This product |
| | | | | | | | | | | does not flow out of a |
| | | | | | | | | | | cooling die well to |
| | | | | | | | | | | create a stable product. |
| | | | | | | | | | | Might be possible as a |
| | | | | | | | | | | seafood replacement, |
| | | | | | | | | | | however, testing in this |
| | | | | | | | | | | area is needed. |
| Example | 0 | 0 | 75 | 0 | 25 | 0 | 0 | 0 | Unknown | It is possible that this |
| 49 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. |
| Example | 0 | 0 | 75 | 0 | 0 | 25 | 0 | 0 | Unknown | It is possible that this |
| 50 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein C. Or the |
| | | | | | | | | | | product would be even |
| | | | | | | | | | | softer and less |
| | | | | | | | | | | desirable because |
| | | | | | | | | | | Protein |
| | | | | | | | | | | F has been too |
| | | | | | | | | | | hydrolyzed. At this |
| | | | | | | | | | | stage, not enough |
| | | | | | | | | | | evidence to say. |
| Example | 0 | 0 | 75 | 0 | 0 | 0 | 25 | 0 | Unknown | It is possible that this |
| 51 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein C. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. If |
| | | | | | | | | | | Protein G does not |
| | | | | | | | | | | provide much |
| | | | | | | | | | | functionality, then |
| | | | | | | | | | | there is likely not |
| | | | | | | | | | | enough of Protein B to |
| | | | | | | | | | | make an acceptable |
| | | | | | | | | | | product. |
| Example | 0 | 0 | 75 | 0 | 0 | 0 | 0 | 25 | Yes | The product is soft and |
| 52 | | | | | | | | | | stretchy. It forms more |
| | | | | | | | | | | flakes and less fibers. |
| | | | | | | | | | | This would be a similar |
| | | | | | | | | | | product to examples 3 |
| | | | | | | | | | | or 8. |
| Example | 0 | 0 | 50 | 50 | 0 | 0 | 0 | 0 | No | Too soft and pliable. |
| 53 | | | | | | | | | | Does not have an |
| | | | | | | | | | | acceptable pull apart |
| | | | | | | | | | | texture. Might be |
| | | | | | | | | | | possible as a seafood |
| | | | | | | | | | | replacement, however, |
| | | | | | | | | | | testing in this area is |
| | | | | | | | | | | needed. This product |
| | | | | | | | | | | likely would not form |
| | | | | | | | | | | fibers but would likely |
| | | | | | | | | | | create a good protein |
| | | | | | | | | | | gel. |
| Example | 0 | 0 | 50 | 0 | 50 | 0 | 0 | 0 | Unknown | It is possible that this |
| 54 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. |
| Example | 0 | 0 | 50 | 0 | 0 | 50 | 0 | 0 | Unknown | It is possible that this |
| 55 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein C. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| Example | 0 | 0 | 50 | 0 | 0 | 0 | 50 | 0 | Unknown | It is possible that this |
| 56 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein C. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. If |
| | | | | | | | | | | Protein G does not |
| | | | | | | | | | | provide much |
| | | | | | | | | | | functionality, then |
| | | | | | | | | | | there is likely not |
| | | | | | | | | | | enough of Protein B to |
| | | | | | | | | | | make an acceptable |
| | | | | | | | | | | product. |
| Example | 0 | 0 | 50 | 0 | 0 | 0 | 0 | 50 | Yes | The product is soft and |
| 57 | | | | | | | | | | stretchy. It forms more |
| | | | | | | | | | | flakes and less fibers. |
| | | | | | | | | | | This would be a similar |
| | | | | | | | | | | product to examples 3 |
| | | | | | | | | | | 8, or 52. |
| Example | 0 | 0 | 25 | 75 | 0 | 0 | 0 | 0 | No | Too soft and pliable. |
| 58 | | | | | | | | | | Does not have an |
| | | | | | | | | | | acceptable pull apart |
| | | | | | | | | | | texture. Might be |
| | | | | | | | | | | possible as a seafood |
| | | | | | | | | | | replacement, however, |
| | | | | | | | | | | testing in this area is |
| | | | | | | | | | | needed. This product |
| | | | | | | | | | | likely would not form |
| | | | | | | | | | | fibers but would likely |
| | | | | | | | | | | create a good protein |
| | | | | | | | | | | gel. |
| Example | 0 | 0 | 25 | 0 | 75 | 0 | 0 | 0 | Unknown | It is possible that this |
| 59 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. |
| Example | 0 | 0 | 25 | 0 | 0 | 75 | 0 | 0 | Unknown | It is possible that this |
| 60 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein C. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| Example | 0 | 0 | 25 | 0 | 0 | 0 | 75 | 0 | Unknown | It is possible that this |
| 61 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein C. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. If |
| | | | | | | | | | | Protein G does not |
| | | | | | | | | | | provide much |
| | | | | | | | | | | functionality, then |
| | | | | | | | | | | there is likely not |
| | | | | | | | | | | enough of Protein B to |
| | | | | | | | | | | make an acceptable |
| | | | | | | | | | | product. |
| Example | 0 | 0 | 25 | 0 | 0 | 0 | 0 | 75 | Yes | The product is soft and |
| 62 | | | | | | | | | | stretchy. It forms more |
| | | | | | | | | | | flakes and less fibers. |
| | | | | | | | | | | This would be a similar |
| | | | | | | | | | | product to examples 3 |
| | | | | | | | | | | 8, 52, or 57. |
| Example | 0 | 0 | 0 | 75 | 25 | 0 | 0 | 0 | Unknown | It is possible that this |
| 63 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. |
| Example | 0 | 0 | 0 | 75 | 0 | 25 | 0 | 0 | Unknown | It is possible that this |
| 64 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein D. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| Example | 0 | 0 | 0 | 75 | 0 | 0 | 25 | 0 | Unknown | It is possible that this |
| 65 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein D. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. |
| Example | 0 | 0 | 0 | 75 | 0 | 0 | 0 | 25 | No | This product would |
| 66 | | | | | | | | | | form a good gel, but |
| | | | | | | | | | | not create a product |
| | | | | | | | | | | with filaments. The |
| | | | | | | | | | | product would be less |
| | | | | | | | | | | cohesive and not a |
| | | | | | | | | | | considered acceptable |
| | | | | | | | | | | for a meat replacement. |
| Example | 0 | 0 | 0 | 50 | 50 | 0 | 0 | 0 | Unknown | It is possible that this |
| 67 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this |
| | | | | | | | | | | stage, not enough |
| | | | | | | | | | | evidence to say. |
| Example | 0 | 0 | 0 | 50 | 0 | 50 | 0 | 0 | Unknown | It is possible that this |
| 68 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein D. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| Example | 0 | 0 | 0 | 50 | 0 | 0 | 50 | 0 | Unknown | It is possible that this |
| 69 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein D. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. |
| Example | 0 | 0 | 0 | 50 | 0 | 0 | 0 | 50 | Somewhat | This product would |
| 70 | | | | | | | | | | form a good gel, but |
| | | | | | | | | | | not create a product |
| | | | | | | | | | | with filaments. The |
| | | | | | | | | | | product would be less |
| | | | | | | | | | | cohesive and not a |
| | | | | | | | | | | considered acceptable |
| | | | | | | | | | | for a meat replacement. |
| | | | | | | | | | | It would be a better |
| | | | | | | | | | | quality product than |
| | | | | | | | | | | Example 66 but likely |
| | | | | | | | | | | not good enough to |
| | | | | | | | | | | commercialize. |
| Example | 0 | 0 | 0 | 25 | 75 | 0 | 0 | 0 | Unknown | It is possible that this |
| 71 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this stage, |
| | | | | | | | | | | not enough evidence to |
| | | | | | | | | | | say. |
| Example | 0 | 0 | 0 | 25 | 0 | 75 | 0 | 0 | Unknown | It is possible that this |
| 72 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein D. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. |
| Example | 0 | 0 | 0 | 25 | 0 | 0 | 75 | 0 | Unknown | It is possible that this |
| 73 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein D. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. |
| Example | 0 | 0 | 0 | 25 | 0 | 0 | 0 | 75 | Somewhat | This product would |
| 74 | | | | | | | | | | form a good gel, but |
| | | | | | | | | | | not create a product |
| | | | | | | | | | | with filaments. The |
| | | | | | | | | | | product would be less |
| | | | | | | | | | | cohesive and not a |
| | | | | | | | | | | considered acceptable |
| | | | | | | | | | | for a meat replacement. |
| | | | | | | | | | | It could possibly make |
| | | | | | | | | | | a good product because |
| | | | | | | | | | | Protein H makes an |
| | | | | | | | | | | acceptable product but |
| | | | | | | | | | | the addition of Protein |
| | | | | | | | | | | D would likely cause |
| | | | | | | | | | | the product to be too |
| | | | | | | | | | | soft. |
| Example | 0 | 0 | 0 | 0 | 75 | 25 | 0 | 0 | Unknown | Neither Proteins have |
| 75 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 75 | 25 | 0 | 0 | Unknown | Neither Proteins have |
| 76 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 75 | 0 | 25 | 0 | Unknown | Neither Proteins have |
| 77 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 75 | 0 | 0 | 25 | Unknown | It is possible that this |
| 78 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this stage, |
| | | | | | | | | | | not enough evidence to |
| | | | | | | | | | | say. If Protein E does |
| | | | | | | | | | | not have functionality |
| | | | | | | | | | | by itself there is likely |
| | | | | | | | | | | not enough of Protein |
| | | | | | | | | | | H to make an |
| | | | | | | | | | | acceptable product. |
| Example | 0 | 0 | 0 | 0 | 50 | 50 | 0 | 0 | Unknown | Neither Proteins have |
| 79 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 50 | 0 | 50 | 0 | Unknown | Neither Proteins have |
| 80 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 50 | 0 | 0 | 50 | Unknown | It is possible that this |
| 81 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this stage, |
| | | | | | | | | | | not enough evidence to |
| | | | | | | | | | | say. If Protein E does |
| | | | | | | | | | | not have functionality |
| | | | | | | | | | | by itself there is likely |
| | | | | | | | | | | not enough of Protein |
| | | | | | | | | | | H to make an |
| | | | | | | | | | | acceptable product. |
| Example | 0 | 0 | 0 | 0 | 25 | 75 | 0 | 0 | Unknown | Neither Proteins have |
| 82 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 25 | 0 | 75 | 0 | Unknown | Neither Proteins have |
| 83 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 25 | 0 | 0 | 75 | Unknown | It is possible that this |
| 84 | | | | | | | | | | makes a good product. |
| | | | | | | | | | | Protein E has not yet |
| | | | | | | | | | | been tested, but |
| | | | | | | | | | | estimates show that it |
| | | | | | | | | | | could make a strong |
| | | | | | | | | | | product that only |
| | | | | | | | | | | partially breaks the |
| | | | | | | | | | | bonds created through |
| | | | | | | | | | | the enzyme treatment. |
| | | | | | | | | | | Or the product fails |
| | | | | | | | | | | because of the enzyme |
| | | | | | | | | | | treatment. At this stage, |
| | | | | | | | | | | not enough evidence to |
| | | | | | | | | | | say. If Protein E does |
| | | | | | | | | | | not have functionality |
| | | | | | | | | | | by itself there is may |
| | | | | | | | | | | be enough of Protein H |
| | | | | | | | | | | to make a product, but |
| | | | | | | | | | | it is unlikely. |
| Example | 0 | 0 | 0 | 0 | 0 | 75 | 25 | 0 | Unknown | Neither Proteins have |
| 85 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 0 | 75 | 0 | 25 | Unknown | It is possible that this |
| 86 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein H. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. If |
| | | | | | | | | | | Protein F does not have |
| | | | | | | | | | | functionality by itself |
| | | | | | | | | | | there is likely not |
| | | | | | | | | | | enough of Protein H to |
| | | | | | | | | | | make an acceptable |
| | | | | | | | | | | product. |
| Example | 0 | 0 | 0 | 0 | 0 | 50 | 50 | 0 | Unknown | Neither Proteins have |
| 87 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 0 | 50 | 0 | 50 | Unknown | It is possible that this |
| 88 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein H. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. If |
| | | | | | | | | | | Protein F does not have |
| | | | | | | | | | | functionality by itself |
| | | | | | | | | | | there is likely not |
| | | | | | | | | | | enough of Protein H to |
| | | | | | | | | | | make an acceptable |
| | | | | | | | | | | product. |
| Example | 0 | 0 | 0 | 0 | 0 | 25 | 75 | 0 | Unknown | Neither Proteins have |
| 89 | | | | | | | | | | yet been tested. |
| | | | | | | | | | | Therefore, a prediction |
| | | | | | | | | | | towards their |
| | | | | | | | | | | combination cannot be |
| | | | | | | | | | | made at this time. |
| Example | 0 | 0 | 0 | 0 | 0 | 25 | 0 | 75 | Unknown | It is possible that this |
| 90 | | | | | | | | | | makes a good product. |
| | | | | | | | | | | Protein F has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein H. Or the |
| | | | | | | | | | | product would be even |
| | | | | | | | | | | softer and less |
| | | | | | | | | | | desirable because |
| | | | | | | | | | | Protein F has been too |
| | | | | | | | | | | hydrolyzed. At this |
| | | | | | | | | | | stage, not enough |
| | | | | | | | | | | evidence to say. If |
| | | | | | | | | | | Protein F does not have |
| | | | | | | | | | | functionality by itself |
| | | | | | | | | | | there is may be enough |
| | | | | | | | | | | of Protein H to make |
| | | | | | | | | | | an acceptable product |
| | | | | | | | | | | but it is unlikely. |
| Example | 0 | 0 | 0 | 0 | 0 | 0 | 75 | 25 | Unknown | It is possible that this |
| 91 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein H. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. if |
| | | | | | | | | | | Protein G does not |
| | | | | | | | | | | have functionality by |
| | | | | | | | | | | itself there is likely not |
| | | | | | | | | | | enough of Protein H to |
| | | | | | | | | | | make an acceptable |
| | | | | | | | | | | product. |
| Example | 0 | 0 | 0 | 0 | 0 | 0 | 50 | 50 | Unknown | It is possible that this |
| 92 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein H. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. if |
| | | | | | | | | | | Protein G does not |
| | | | | | | | | | | have functionality by |
| | | | | | | | | | | itself there is likely not |
| | | | | | | | | | | enough of Protein H to |
| | | | | | | | | | | make an acceptable |
| | | | | | | | | | | product. |
| Example | 0 | 0 | 0 | 0 | 0 | 0 | 25 | 75 | Unknown | It is possible that this |
| 93 | | | | | | | | | | makes a good product. |
| | | | | | | | | | | Protein G has not yet |
| | | | | | | | | | | been tested, but |
| | | | | | | | | | | estimates show that it |
| | | | | | | | | | | could make a strong |
| | | | | | | | | | | product because the |
| | | | | | | | | | | protein has already |
| | | | | | | | | | | been partially cleaved |
| | | | | | | | | | | that it would realign |
| | | | | | | | | | | with the untreated |
| | | | | | | | | | | Protein H. Or the |
| | | | | | | | | | | product would be even |
| | | | | | | | | | | softer and less |
| | | | | | | | | | | desirable because |
| | | | | | | | | | | Protein G has been too |
| | | | | | | | | | | hydrolyzed. It would |
| | | | | | | | | | | likely by comparable to |
| | | | | | | | | | | combinations with |
| | | | | | | | | | | Protein F but with |
| | | | | | | | | | | more water binding |
| | | | | | | | | | | properties. At this |
| | | | | | | | | | | stage, not enough |
| | | | | | | | | | | evidence to say. if |
| | | | | | | | | | | Protein G does not |
| | | | | | | | | | | have functionality by |
| | | | | | | | | | | itself there is likely not |
| | | | | | | | | | | enough of Protein H to |
| | | | | | | | | | | make an acceptable |
| | | | | | | | | | | product. |

Note:
HME* in the Product Characteristics is shorthand for the processed extrudate product and/or flavored processed extrudate product.

Table 1 discloses four exemplary proteins, Proteins A, B, C, and D, in terms of various characteristics (e.g., PDI, NSI, pH, protein content, sedimentation, etc.). Table 2 discloses the combination pairs of Proteins A, B, C, D, E, F, G, and H across three sets of distribution ratios (100%, 75:25 and 25:75, and 50:50) as well as the results of using the combination pairs at each distribution ratio as the legume, protein products for example implementation 100.

In some implementations, the legume, protein, extrudate product, processed extrudate product, flavored processed extrudate product, and/or the final food product may be manipulated and/or shaped into a meat-like food product that may be comparable to chicken breasts. For example, the processor may process the legume, protein, extrudate product into extrudate cutlets. The cooler may cool the extrudate cutlets to a temperature range of −40-0° C. The processor may marinate the extrudate cutlets in a solution comprising sodium alginate and/or chicken skin flavoring. The sodium alginate solution can be a viscous solution, similar to syrup, and can cause the outside of the processed extrudate product, or flavored processed extrudate product to become firmer or tougher than the inside of said products and form a pseudoskin around said products. The sodium alginate solution can modify the outside or outer surface of the processed extrudate product, or flavored processed extrudate product by creating a moisture barrier. The sodium alginate solution can comprise calcium and the sodium alginate can take up the calcium and turn into a film that can be peeled off the processed extrudate product, or flavored processed extrudate product. A pseudoskin skin can be formed by the sodium alginate solution can create a texture is similar to the texture of cooked foul or other animal mean products and is noticed when cutting or biting into the final food product described in this disclosure. The processor may marinate the extrudate cutlets in a solution comprising calcium chloride. The processor may heat the extrudate cutlets to a desired heat.

In some implementations, the legume, protein, extrudate product, processed extrudate product, flavored processed extrudate product, and/or the final food product may be manipulated and/or shaped into a meat-like food product that may be comparable to jerky. For example, the processor may process the legume, protein, extrudate product into processed extrudate strips. The mixer may mix a selection of spices, herbs, salts, sugars, fats/oils, chemical tenderizers, flavoring, color, and/or curing agents into a mixture of seasonings and form flavored processed extrudate strips. The mixture of seasonings may be either a dry or liquid blend. If the mixture of seasonings is a dry blend, the mixture of seasonings may be applied uniformly to each surface of the processed extrudate strips. If the mixture of seasonings is a liquid blend, the processed extrudate strips may be marinated in the processor with the mixture of seasonings to form flavored processed extrudate strips. In some implementations, the processor tenderizes the extrudate strips. The processor may dehydrate the extrudate strips.

In some implementations, the legume, protein, extrudate product, processed extrudate product, flavored processed extrudate product, and/or the final food product may be manipulated and/or shaped into a meat-like food product that may be comparable to, for example, sausages. For example, residual legume, protein, extrudate product, legume, protein, processed extrudate product, legume, protein, flavored processed extrudate product, and/or final food product left over from the formation of other meat-like products may be gathered, collected, and/or recycled to make this and other meat-like food products. The processor may process the left over or residual extrudate product, processed extrudate product, flavored processed extrudate product, and/or final food product, into a recaptured product. The mixer may mix a selection of binders and/or thickening agents with water. The mixer may mix the binders and/or thickening agents with water until the mixture is uniformly smooth. The mixer may mix a selection of spices, herbs, salts, sugars, fats/oils, flavoring, color, and/or gelling agents into a mixture of seasonings into the recaptured product. The mixture of seasonings may be mixed with the mixture of binders and/or thickening agents with water to form a mixture of seasonings and binding agents. The mixer may mix the recaptured product with the mixture of seasonings and binding agents to make a recaptured food product, such as a sausage material, a meat-like patty, or deli-like meat products.

The recaptured food product may be stuffed into a casing (e.g., like a non-animal based sausage casing) to make a meat-like sausage. The casing may be made out of plant materials, synthetic food grade materials, and/or combinations thereof. The processor may heat the recaptured food product to a desired heat.

### Recaptured Food Product Formulation Examples

| | | Final Food |
|---|---|---|
| | Starter | Product Ranges |
| Ingredient | Formula (wt. %) | (wt. %) |
| Residual or Recapture | 56% | 30-70% |
| Extrudate | | |
| Water | 40% | 30-50% |
| Binders | 1.25% | 0.5-5% |
| Flavors | 0.75% | 0-5% |
| Fats/Oils | 10% | 0-20% |
| Colors | 2% | 0-4% |
| Pea Protein | 6% | 2-10% |
| Seasonings/herbs/spices | 3% | 0-7% |

The exemplary formulas above comprise exemplary ratios and addition of ingredients that utilize the left over or residual extrudate product and recycle or recapture the residual extrudate product to make other food products. The recaptured food product may be in a food product form that is shredded, a patty, or a sausage.

The recaptured food product could comprise at least about 30% by weight of the left over or residual extrudate product. If the recaptured food product comprises any less than 30% by weight, the recaptured food product can be too mushy or lack the proper structure, for example not be fibrous or firm and flaky on the inside, to be meat-like. The recaptured food product can comprise at most about 70% by weight of the recaptured extrudate. If the recaptured food product comprises more than 70% by weight of the left over or residual extrudate product, the recaptured food product may not have structural integrity and may, for example, fall apart. This can be because the binder(s) do not have the ability to hold the structure of the recaptured food product together. The water may be as low as 30% by weight. If the water is lower, the binder, flavors, colors, protein, and/or seasoning(s)/herb(s)/spice(s) may not be activated or be able to function. Also, the recaptured food product may be too dry. The water may be about 50% by weight at most. If the water content is any higher, the recaptured food product may not be able to maintain structural integrity. The binder(s) may be 0.5% to 5% by weight. If the binder is at a higher concentration, the binder(s) may begin to negatively impact the sensory characteristics of the recaptured food product. The flavor(s) may be 0% if the final product is desired to be unflavored upon delivery to the consumer or to be flavored later. The flavor(s) may be at most about 5% by weight. Flavors as referred to here can be artificial or natural flavors meant to mimic the taste of meat or fat, or to enhance the sensory characteristics of a product, such as mouth feel, chew, taste, smell, or other characteristics that impact the experience of eating. The fat(s)/oils(s) may be 0% by weight as fat/oil may not necessary to form the recaptured food product. The fat(s)/oil(s) may be at most about 20% by weight. If fat(s)/oil(s) are added in higher amounts, the fat/oil may begin to disrupt the recaptured food product's ability to maintain a firm structure and cause the product to crumble or break easily. The color(s) may be 0% as color may not be necessary for the formation of the recaptured food product. Color may be omitted if the color of the recaptured food product is already desirable (for example, a chicken patty). The color(s) may be at most about 4% by weight. If color is added at a higher level, the color may begin to impact the flavor of the recaptured product or other sensory attributes. The protein content of the recaptured food product may at least 2%. If the recaptured food product comprises a lower amount, it may not maintain an adequate structure and lack a meat-y mouthfeel, or the pea protein will not be able to adequately disperse the binder(s), flavor(s), color(s), and/or seasonings/herbs/spices throughout the matrix. The protein content of the recaptured food product can be up to about 10% by weight. If the protein content is higher, the recaptured food product may have a gritty/chalky mouthfeel. The seasoning(s)/herb(s)/spice(s) content may be 0% as they may not be necessary for the formation of the product. The seasoning(s)/herb(s)/spice(s) content of the recaptured food product may be up to about 7%. If the concentration is any higher, and the effect of the inclusions may be lost or overpowering.

The left over or residual extrudate product used in recaptured meat applications can create a shredded meat-like texture when compared to the use of a rehydrated textured pea protein created through dry extrusion, which could create a more ground meat-like texture. A product such as a patty or an encased link that comprises the left over or residual extrudate product can be softer, and/or have more of a tear-like bite and more closely resemble a fish or chicken type product. It may also resemble a re-structured whole muscle pork or beef product. A product made with a dry textured protein as the base may have more springiness and resistance with a more clean-cut bite and more closely resemble a ground turkey or beef product.

The left over or residual extrudate product may also be re-ground into a powder-like consistency to be used in deli-like meat applications. The re-grinding of the left over or residual extrudate product can be performed to create a smooth consistency allowing for a homogenous interior of formed deli-like meat applications.

In some implementations, the residual extrudate product, legume, protein, extrudate product, processed extrudate product, flavored processed extrudate product, final food product, and/or recaptured food product may be manipulated and/or shaped into a meat-like food product that may be comparable to patties. In these implementations, the residual extrudate product, processed extrudate product, flavored processed extrudate product, final food product, and/or recaptured food product left over from the formation of other meat-like products may be gathered, collected, and/or recycled to make this and other meat-like food products. The processor may process the residual extrudate product, processed extrudate product, flavored processed extrudate product, and/or final food product into a ground or shredded product that can be processed, flavored, or be the final food product. The mixer may mix a selection of binders and/or thickening agents with water.

The mixer may mix the binders and/or thickening agents with water until the mixture is uniformly smooth. The mixer may mix a selection of spices, herbs, salts, sugars, fats/oils, flavoring, color, and/or gelling agents into a mixture of seasonings. The mixture of seasonings may be mixed with the mixture of binders and/or thickening agents with water to form a mixture of seasonings and binding agents. The mixer may mix the ground recaptured product with the mixture of seasonings and binding agents to make a patty material. The patty material may be compressed or shaped into a patty product and the processor may heat the patty product to a desired temperature using heat or steam.

In some implementations, the legume, protein, extrudate product, processed extrudate product, flavored processed extrudate product, the final food product, ground product, and/or recaptured product may be manipulated and/or shaped into a meat-like food product that may be comparable to fermented sausages (e.g., pepperoni, salami, etc.). In these implementations, residual product and/or recaptured product left over from the formation of other meat-like products may be gathered, collected, and/or recycled to make this type of food product and other meat-like food products. The residual product, recaptured food product, or ground product may be processed, flavored, and formed into a final food product as described above. The mixer may mix a selection of binders and/or thickening agents with water. The mixer may mix the binders and/or thickening agents with water until the mixture is uniformly smooth. The mixer may mix a selection of spices, herbs, salts, sugars, fats/oils, flavoring, color, and/or gelling agents into a mixture of seasonings. The mixture of seasonings may be mixed with the mixture of binders and/or thickening agents with water to form a mixture of seasonings and binding agents. The mixer may mix legume, protein, extrudate product, the legume, protein, processed extrudate product, the legume, protein, flavored processed extrudate product, and/or the final food product and/or recaptured product with the mixture of seasonings and binding agents to make a legume, protein, extrudate sausage material. The legume, protein, extrudate sausage material may be stuffed into a casing (e.g., a non-animal based sausage casing) to make a legume, protein, extrudate sausage and the casing may be made out of plant materials, food grade synthetic materials, and/or combinations thereof. If fermented flavorings are chosen to be applied to the legume, protein, extrudate sausage, then the processor may heat the legume, protein, extrudate sausage to a desired heat while the fermented flavorings are applied to the legume, protein, extrudate sausage. If traditional fermentation is chosen to be performed on the legume, protein, extrudate sausage, then the legume, protein, extrudate sausage may ferment in a controlled environment for at least 24 hours to make the legume, protein, extrudate fermented sausage. The legume, protein, extrudate fermented sausage may then be dried in a controlled environment for at least 72 hours. The processor may heat the legume, protein, extrudate fermented sausage to a desired heat.

In this way, the meat-like food product may be a substitute for cooked meat-based food products by having a comparable consistency, texture, taste, and/or appearance to animal-based meat products.

The foregoing description is not limited by the equipment used, the methods described, or the order of such methods. While steps are often described in a consecutive or ordering manner, the method disclosed herein is not limited to the specific ordering of these steps. Rather, such an ordering of steps should be treated as a single, non-limiting, exemplary implementation of the present disclosure.

Since many modifications, variations, and changes in detail can be made to the described implementations of the disclosure, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A legume, protein, extrudate product comprising:
a mixture of at least one carbohydrate product and a combination of at least two non-soy, legume, protein products,
wherein each of the non-soy, legume, protein products differ in at least one value selected from the group consisting of pH, sedimentation level test value, Nitrogen Solubility Index test value, protein, Dispersibility Index test value, particle size distribution, and viscosity,
wherein the legume, protein, extrudate product comprises at least 70% dry weight in the combination of the at least two non-soy, legume, protein products,
wherein the combination of the at least two non-soy, legume, protein products comprise a distribution ratio ranging from a 50:50 distribution ratio to a 90:10 distribution ratio between the at least two non-soy, legume, protein products,
wherein a moisture content of the legume, protein, extrudate product is less than 70% total weight of the legume, protein, extrudate product, and
wherein a density of the legume, protein, extrudate product is in the range of 0.8-3.0 g/cm³.

2. The legume, protein, extrudate product of claim 1, wherein each of the at least two non-soy, legume, protein products comprise at least 50% dry weight in protein and at least 20% of the dry weight in protein is soluble at about 21° C. with a pH in the range of 4-8.

3. The legume, protein, extrudate product of claim 2, wherein each of the at least two non-soy, legume, protein products have a sedimentation level test value of less than about 20 mL as measured by Solubility Testing Using Centrifuge, a Nitrogen Solubility Index test value of at most 40 as measured by Nitrogen Solubility Index, and a Protein Dispersibility Index test value of at most 90 as measured by Protein Dispersibility Index.

4. A final food product comprising:
the legume, protein, extrudate of claim 1, wherein the final food product comprises:
an inner texture that is fibrous when pulled apart; and
at least one aspect selected from the group consisting of a consistency, a taste, and an appearance, wherein said final food product is comparable to a cooked fowl, a cattle, a swine, or ovine meat product.

5. The legume, protein, extrudate product of claim 1, wherein the at least one carbohydrate product comprises at least one component selected from the group consisting of a legume, fiber product, a legume, starch product, and a legume, flour product.

6. A flavored extrudate product comprising:
the legume, protein, extrudate product of claim 1; and
at least one ingredient selected from the group consisting of flavors, colors, flavor suppressants, flavor maskers, fruit powders, fruit concentrates, fruit flavors, spices, spice oils, sweeteners, sugars, syrups, salts, polyols, whiteners, and titanium dioxide.

7. A method of manufacture of a legume, protein, extrudate product, the method comprising:
weighing at least two non-soy, legume, protein products and at least one carbohydrate product,
wherein the at least two non-soy, legume, protein products and the at least one carbohydrate product comprise a range of 70-100% dry weight of a total weight of the legume, protein, extrudate product,
wherein the at least two non-soy, legume, protein products comprise a distribution ratio ranging from a 50:50 distribution ratio to a 90:10 distribution ratio between the at least two non-soy, legume, protein products;
mixing the at least two non-soy, legume, protein products and the at least one carbohydrate product to make a mixture of non-soy, legume, protein and carbohydrate products,
wherein each of the at least two non-soy, legume, protein products differ in at least one value selected from the group consisting of pH, sedimentation level test value, Nitrogen Solubility Index test value, protein, Dispersibility Index test value, particle size distribution, and viscosity;
preconditioning the mixture of non-soy, legume, protein and carbohydrate products by mixing the mixture of non-soy, legume, protein and carbohydrate products at a speed of about 100-1500 rpms to form a legume, protein, pre-extrudate;
extruding the legume, protein, pre-extrudate to form a legume, protein, extrudate product; and
processing the legume, protein, extrudate product to form a processed extrudate product by performing at least one action selected from the group consisting of shearing, cutting, chopping, shredding, grinding, compressing, kneading, rolling, tumbling, tenderizing, reducing, darkening, boiling, broiling, grilling, frying, roasting, baking, smoking, steaming, dehydrating, pickling, marinating, and freeze drying to form a processed extrudate product.

8. The method of manufacture of the legume, protein, extrudate product of claim 7, wherein mixing the at least two non-soy, legume, protein products and the at least one carbohydrate product comprises:
mixing the mixture of non-soy, legume, protein and carbohydrate products until the mixture of non-soy, legume, protein and carbohydrate products is homogenous.

9. The method of manufacture of the processed extrudate product of claim 7, wherein preconditioning the mixture of non-soy, legume, protein and carbohydrate products to form the legume, protein, pre-extrudate comprises:
heating the mixture of non-soy, legume, protein and carbohydrate products to a temperature of 25-100° C.

10. The method of manufacture of the processed extrudate product of claim 9, wherein the forming the pre-extrudate comprises:
adding water or oil or combinations thereof to the mixture of non-soy, legume, protein and carbohydrate products; and
adding at least one ingredient selected from the group consisting of flavors, colors, flavor suppressants, flavor maskers, colors, fruit powders, fruit concentrates, fruit flavors, spices, spice oils, sweeteners, sugars, syrups, salts, polyols, whiteners, and titanium dioxide to the mixture of non-soy, legume, protein and carbohydrate products.

11. The method of manufacture of the legume, protein, extrudate product of claim 7, wherein extruding the legume, protein, extrudate product comprises:
forming a legume, protein, pre-extrudate product;
putting the legume, protein, pre-extrudate product into an extruder feeder that feeds material into an extruder;
processing the legume, protein, pre-extrudate product in a mixing zone of the extruder to form a processed extrudate product;
heating the processed extrudate product to a temperature range of about 110-150° C.; and
adding flavoring to the processed extrudate product to form a flavored processed extrudate product.

12. A method of forming a flavored extrudate product comprising the non-soy, legume, protein, extrudate product of claim 7, wherein the method comprises:
injecting the legume, protein, extrudate with at least one ingredient selected from the group consisting of flavors, colors, flavor suppressants, flavor maskers, colors, fruit powders, fruit concentrates, fruit flavors, spices, spice oils, sweeteners, sugars, syrups, salts, polyols, whiteners, and titanium dioxide; and
forming a flavored processed extrudate product.

13. A method of forming a food product comprising the flavored processed extrudate product of claim 7, wherein the method comprises:
cooling the flavored processed extrudate to a temperature of at most 0° C.;
shaping the flavored processed extrudate product into a meat product shape;
marinading the meat product shape in a sodium alginate solution to form a moisture barrier on an exterior surface of the meat product shape and form a final food product, wherein the moisture barrier forms a pseudoskin; and
packaging the final food product for shipment and distribution.

14. A method for forming a recaptured food product comprising the flavored processed extrudate product of claim 7, wherein the method comprises;
cooling the flavored processed extrudate;
shaping the flavored processed extrudate product into a meat product shape;
collecting the excess flavored processed extrudate product left over from the shaping to form a left over or residual extrudate product;
adding water to the left over or residual extrudate product, wherein the water is 30% to 50% by weight of the recaptured food product;
adding at least one binder to the left over or residual extrudate product, wherein the at least one binder is 0.5% to 5% by weight of the recaptured food product; and
and forming the left over or residual extrudate product comprising the added water and added at least one binder into a meat-like food product shape to create the recaptured food product.

15. The method of claim 14, wherein the recaptured food product is a shredded food product or a sausage food product.

16. The method of claim 14, further comprising grinding the left over or residual extrudate product comprising the added water and added at least one binder into a powder-like consistency to create a ground recaptured product and forming the ground recaptured product into a deli-like meat product comprising a homogenous consistency in an interior of the deli-like meat product.

17. A meat-like food product comprising:
the legume, protein, extrudate product of claim 1; and
at least one aspect from a group comprising an inner fibrous consistency, a smooth outer texture of an outer surface of the meat-like food product, a meat-like taste, and a meat-like appearance,
wherein the aspect is comparable to one of a cooked meat product of a fowl, a cattle, a swine, or an ovine, and
wherein an inside of the meat-like food product is flaky in texture when pulled apart.

18. The meat-like food product of claim 17, wherein the aspect is comparable to jerky, sausages, fermented sausages, or meat patties.

19. The meat-like food product of claim 17, wherein the smooth outer surface is tougher to cut through than the inner fibrous and the meat-like food product is comparable to chicken breasts, chicken cutlets, and turkey breast.

20. The meat-like food product of claim 19, where in a sodium alginate solution is applied to the outer surface of the meat-like food product and creates a moisture barrier that and forms the smooth outer surface that is tougher to cut through than the inside.
